(19) United States
(12) Patent Application Publication
(10) Pub. No.: US 2011/0170805 A1
(43) Pub. Date: Jul. 14, 2011

(54) Accessory fixture for temporary shelter

(76) Inventor: Terry Alan Harmston, Isanti, MN (US)

(21) Appl. No.: 12/930,465

(22) Filed: Jan. 7, 2011

Related U.S. Application Data
(60) Provisional application No. 61/293,353, filed on Jan. 8, 2010.

(51) Int. Cl. B65D 30/22; F16B 2/02; F16B 45/00; F16M 13/02

(52) U.S. Cl. 383/38; 248/226.11; 248/222.14

(57) ABSTRACT

An accessory fixture for use in organizing and storing personal articles within a temporary shelter, the fixture primarily comprising an accessory support bar outfitted with a mix and match arrangement of useable fixtures in the nature of a pouch, a shelf, one or more hooks, a gun support, a crossbow support, and/or a beverage container holder. The fixture connects to an arrangement of cross rails generally present within the shelter by means of a clamping assembly, which comprises a locking bar having an elongate intermediate member situated in between and connected to a pair of adaptive ends with threaded tip portions suited to receiving end fasteners, the adaptive ends being generally orientated in a perpendicular manner to the accessory support bar and elongate intermediate member to securely and tightly capture thereinbetween the cross rails.

### CROSS-REFERENCE TO RELATED APPLICATIONS

This application claims the benefit of U.S. Provisional Patent Application No. 61/293,353, filed Jan. 8, 2010, entitled “Accessory Fixture for Temporary Shelter,” the disclosures of which, including all attached documents, are incorporated herein by reference in their entirety for all purposes.

### FIELD OF THE INVENTION

The present invention generally relates to an accessory fixture for adaptation to a temporary shelter, whereby the fixture furthers good housekeeping practices and organization of personal belongings in the nature of clothing and accessories associated with outdoor activities of hunting, fishing and camping, to name a few, the accessory fixture primarily being positioned and mounted within an interior chamber of the temporary shelter.

### BACKGROUND OF THE INVENTION

Hunting, fishing, hiking, camping, to name a few, are activities one often associates with the great outdoors. Many enthusiasts participate in their respective outdoor activity by packing and carrying a variety of personal belongings, clothing, food, and outdoor gear to their final destination and depending on the length of stay, may set up a temporary shelter in form of a tent or ground blind that can be generally characterized by walls in tensioned support by one or more hubs and cross rail arrangements. Such shelter configurations may include those commonly known in the art as a hub style ground blind, but need not be so limited. Temporary structures generally directed to activities of hunting and camping, in particular, are known to utilize a hub and cross rail system for tensioning a non-rigid or a flexible element, such as a skin, fabric, sheeting, etc. In as much as such horizontal configurations adequately provide a roof structure, such vertical configurations provide one or more wall structures. The art is replete with commercial structures that preferentially comprise inherent features of compact storage, easy setup and sturdiness of the hub and cross rail arrangement for a more protective interior and comforting environment, such as those offered, for example and without limitation, by Ameristep (Michigan, USA) and Primos Hunting Calls (Mississippi, USA).

Since shelters of the type denoted herein are preferably designed by definition as providing temporary living quarters, most and if not all comprise limited floor space for the essentials, generally being configured to accommodate one or more persons with limited personal articles, leaving little to no space for supplemental personal belongings, clothing, food, and outdoor gear that may be needed for a more prolong stay in the outdoor environment. Even though it is quite plausible to meticulously organize and tidy the interior of the temporary shelter configuration insofar to accommodate one or more persons with limited personal articles, the ability to actively engage in one's sport of hunting from within a ground blind, for example, may be more daunting and troublesome to most and could perhaps cause injury to oneself and others where one must maneuver over and about personal articles stored therewithin. One could only imagine the dangers associated with retrieval of a firearm over personal articles and sleeping gear and taking shot of flying or ground animals from within the ground blind shared by fellow hunting enthusiasts. In furthering aspects of one's safety and comfort, one must generally resort to supplemental storage, whether it is a neighboring vehicle or another temporary shelter. A shelter that desirably attains a more comforting environment to its occupants, particularly where one would primarily engage in activities of sleep and perhaps shoot a firearm while hunting from within the interior chamber of a temporary ground blind, for example, unequivocally yields a more enjoyable outdoor experience.

Needless to say, whether hunting, fishing, observing wildlife, hiking, mountaineering, camping, etc., activities associated with a temporary structure is greatly aided by organization and good housekeeping practices. While attempts have been made to support a variety of activity specific accessories from the structural elements of the hub style structures, the approaches generally comprise a less than ideal suspension arrangement characterized by a hanging strap for securement about a cross rail of the hub system, or a draping type arrangement for a cloth shelf or pouch pack. In light of the state of the art, it remains advantageous to supply a structurally sound, reliable, hand operated fixture or platform which may be readily adapted to store, hold, retain, support accessories in furtherance of the activities pursued or associated with the hub style structure.

### BRIEF SUMMARY OF THE INVENTION

In order to overcome the numerous drawbacks apparent in the prior art, an accessory fixture has been devised for a temporary shelter, more notably in the form of a hub style ground blind incorporating into its design a hub and cross rail system for tensioning a non-rigid or a flexible element, such as a skin, fabric, or sheeting.

It is an object of the present invention to provide an accessory fixture that readily adapts and securely mounts to a stock arrangement of cross rails associated with the ground blind without the requirements of supplemental tools and hardware.

It is yet another object of the present invention to provide an accessory fixture that can be readily outfitted with numerous accessories that support firearms, crossbows and other forms of weaponry for ready and convenient retrieval while hunting from within the ground blind and hold for periods of time articles of clothing, small personal items, beverage containers, etc. to yield greater space for its occupants insofar to further one's comfort and safety.

It is yet another object of the present invention to provide an accessory fixture that can be conveniently stowed along with the temporary structure in compact form.

It is yet another object of the present invention to provide an accessory fixture that is solidly and rigidly constructed to offer reliable, long-term performance.

It is another object of the present invention to provide an accessory fixture that comprises a lesser number of components and no moving parts to which effectively contributes to a lesser cost of manufacture and reduced susceptibility of failure.

It is yet another object of the present invention to provide an accessory fixture which accomplishes the foregoing and other objects and advantages and which is economical, durable, and fully effective in performing its intended functions.

In accordance with the present invention an accessory fixture has been devised for a temporary shelter having a pair of angularly orientated cross rails connected to and emanating from a hub, the accessory fixture comprising an accessory support bar having a predetermined length that at least approximates the separable distance in between the pair of cross rails and first and second ends each having an aperture extending therethrough; a clamping assembly in the preferred form of a locking bar having an elongate intermediate member integrally connected to and situated in between first and second adaptive ends each having a threaded tip portion suited for receiving an end fastener, the adaptive ends being generally orientated in a perpendicular manner to the accessory support bar and elongate intermediate member to securely and tightly capture thereinbetween the cross rails; and a mix and match arrangement of useable fixtures affixed to the accessory support bar, primarily in the nature of a pouch, a shelf, or one or more hooks, gun supports, crossbow supports, and a beverage container holders.

Other objects, features, and advantages of the present invention will become apparent in the following detailed description of the preferred embodiments thereof when read in conjunction with the accompanying drawings in which like reference numerals depict the same parts in the various views.

### BRIEF DESCRIPTION OF THE SEVERAL VIEWS OF THE DRAWINGS

A preferred embodiment of the present invention will now be described by way of example with reference to the accompanying drawings, in which:

FIG. 1 is a front perspective view of the preferred embodiment of the present invention illustrating a cross rail and hub arrangement of a temporary shelter having attached thereto an accessory support bar connected to a shelf comprising hooks and a beverage container holder attached to its frame;

FIG. 2 is a front side elevational view of the preferred embodiment of the present invention illustrating an accessory support bar connected with hooks and a beverage container holder;

FIG. 3 is a top plan view of the preferred embodiment of the present invention illustrating a locking bar and an accessory support bar connected with hooks and a beverage container holder;

FIG. 4 is a front side elevational view of the preferred embodiment of the present invention illustrating an accessory support bar connected with hooks and a crossbow support;

FIG. 5 is a top plan view of the preferred embodiment of the present invention illustrating an accessory support bar connected with hooks and a crossbow support;

FIG. 6 is a front side elevational view of the preferred embodiment of the present invention illustrating a hanger comprising a planar member with integrated planar hook elements;

FIG. 7 is a top plan view of the preferred embodiment of the present invention illustrating a clamping assembly in the form of frictional connectors and a hanger comprising a planar member with integrated planar hook elements;

FIG. 8 is a front side elevational view of the preferred embodiment of the present invention illustrating an accessory support bar connected to a pouch comprising a large compartment fitted with a flap, a zippered compartment, and a frontal accessible compartment;

FIG. 9 is a cross sectional view of the preferred embodiment of the present invention taken along lines 9-9 in FIG. 3 illustrating an accessory support bar connected to a pouch comprising a large compartment fitted with a flap, a zippered compartment, and a frontal accessible compartment;

FIG. 10 is a backside elevational view of the preferred embodiment of the present invention illustrating a pouch connected to and suspended from an accessory support bar;

FIG. 11 is a top plan view of the preferred embodiment of the present invention illustrating a locking bar and an accessory support bar fixedly connected to a shelf comprising hooks and a beverage container holder attached to its frame;

FIG. 12 is a front side elevational view of the preferred embodiment of the present invention illustrating an accessory support bar fixedly connected to a shelf comprising hooks and a beverage container holder attached to its frame;

FIG. 13 is a front side elevational view of the preferred embodiment of the present invention illustrating an accessory support bar connected with hooks and a gun support; and

FIG. 14 is a top plan view of the preferred embodiment of the present invention illustrating a locking bar and an accessory support bar connected with hooks and a gun support.

### DETAILED DESCRIPTION OF THE INVENTION

While this invention is susceptible of being embodied in many different forms, the preferred embodiment of the invention is illustrated in the accompanying drawings and described in detail hereinafter with the understanding that the present disclosure purposefully exemplifies the principles of the present invention and is not intended to unduly limit the invention to the embodiments illustrated and presented herein. The present invention has particular utility as an accessory fixture that can be readily outfitted with numerous forms of accessories that are directed to supporting firearms, crossbows and other forms of weaponry for ready retrieval thereof while hunting from within a temporary shelter such as a hub style ground blind, for example, and holding for periods of time articles of clothing, small personal items, beverage containers, etc. to yield greater space for its occupants insofar to further one's organization, comfort and safety while residing therewithin.

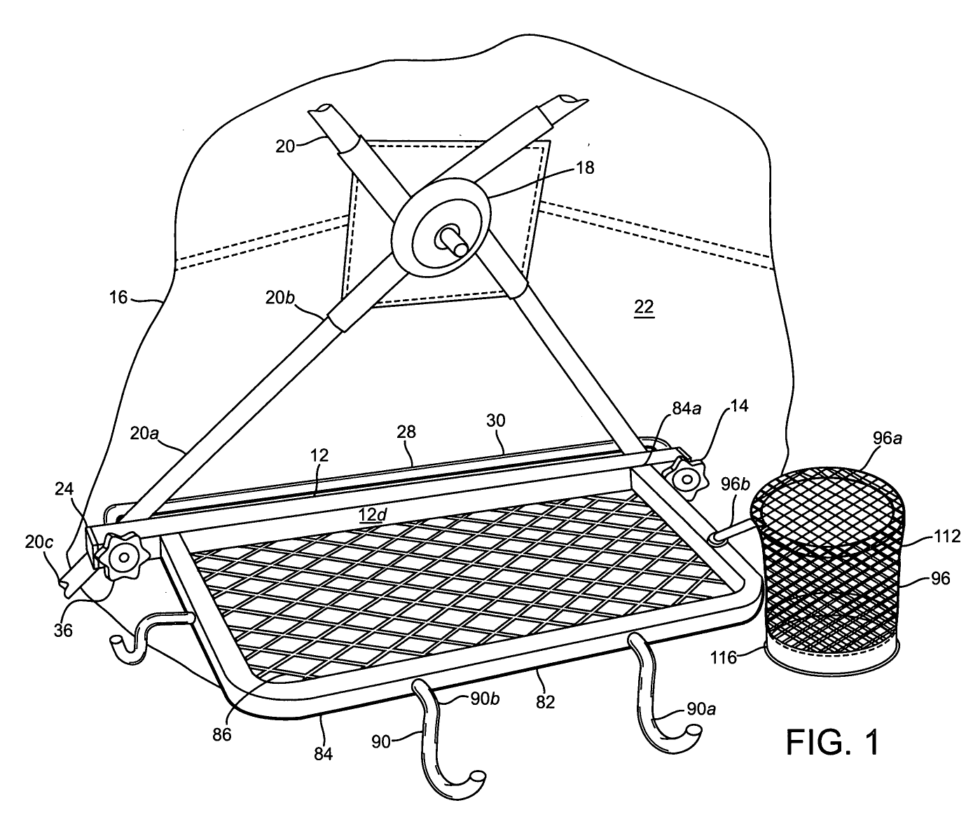

Referring now to FIG. 1, there is shown generally at 10 an accessory fixture comprising an accessory support bar 12 cooperating with a clamping assembly 14 for placement within and attachment to select structural members of a temporary shelter, most notably in the form of a hub style ground blind 16. For purposes of illustration, the hub style ground blind 16 is shown in FIG. 1 to comprise a hub 18 and cross rail system 20 generally being configured to permit tensioning of a non-rigid or a flexible element 22, such as a skin, fabric, sheeting, etc. In as much as a horizontal configuration of one or more cross rails 20 covered with a non-rigid element adequately serves as a roof structure, vertical configurations thereof equally serve as one or more wall structures. It should be readily appreciated that the height of the hub 18 in relation to the floor or ground may vary from one configuration to the next. Moreover, it is understood that the cross rails in the construct of the ground blind 16 in particular are generally angularly orientated outward relatively from the hub where first ends 20b of the cross rails connect, typically being arranged in the manner depicted in FIG. 1. Accordingly, the span or distance in between a pair of cross rails 20, for instance, is minimized at or near the hub 18 and maximized at or near the ground surface where second ends 20c of the cross rails potentiality engage therewith.

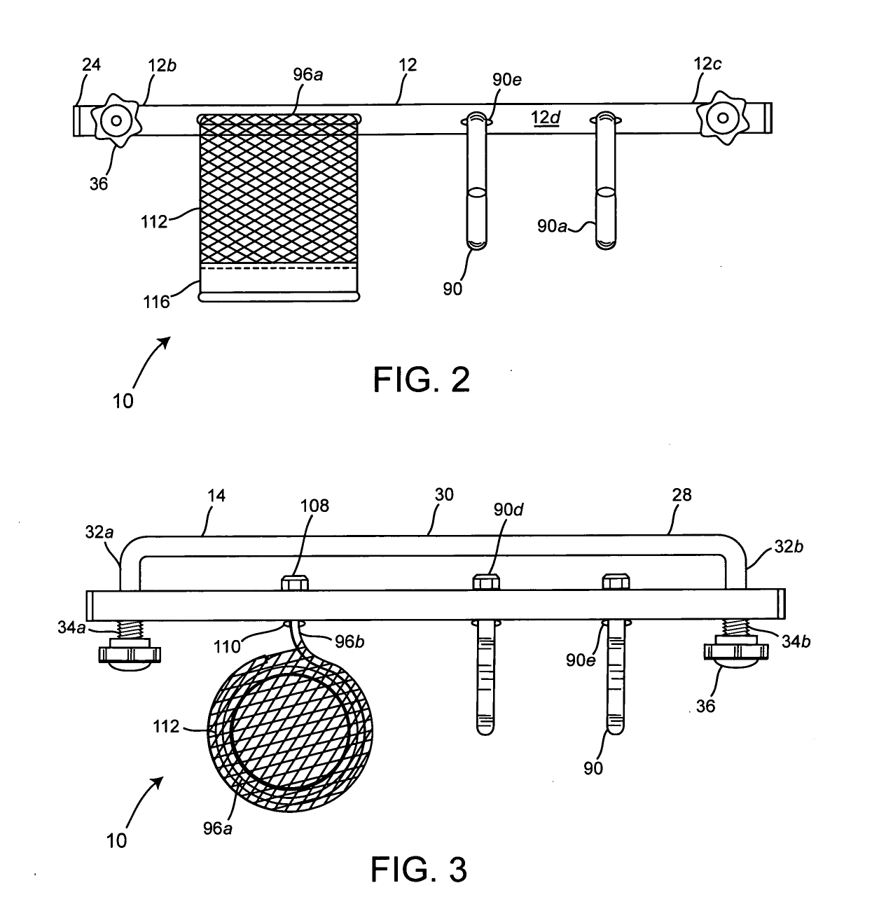

Referring now to FIGS. 2 and 3, the accessory support bar 12 preferentially comprises an overall geometric configuration resembling an elongate tubular member 12a having in general a square-shaped cross section and a predetermined length that at least approximates the separable distance or span in between the pair of cross rails 20. First and second ends 12b, 12c of the accessory support bar 12 each comprise an end cap 24 for protection thereof and an aperture 26 positioned inwardly from the end cap to accept and attach thereto the clamping assembly 14. As illustrated in FIG. 3, the clamping assembly in the preferred embodiment of the accessory fixture comprises a locking bar 28 of the type having an elongate intermediate member 30 integrally connected to and situated in between first and second adaptive ends 32a, 32b, each preferentially being configured to extend perpendicularly outward from the elongate intermediate member, thus establishing an overall u-shaped configuration of the locking bar. The first and second adaptive ends 32a, 32b of the locking bar are further shown in FIG. 3 to comprise a threaded tip portion 34a, 34b that is suited to threadably accept and attach thereto a star handle 36 having a threaded aperture 36a extending therethrough, a wing nut, a hex nut, or an equivalent form of end fastener. A star handle, or alternatively a wing nut, in this strict regard is preferred over other forms of end fasteners such as a hex nut given their inherent capability to allow one to thread and tightly secure it to the threaded tip portion without resorting to use of hand tools or equivalent, thus providing for quick and efficient assembly and disassembly of the accessory fixture 10. Assembly of the preferred embodiment of the clamping assembly 14, as exemplified in FIG. 3, occurs by way of placing first and second adaptive ends 32a, 32b of the locking bar into the apertures of the first and second ends 12b, 12c of the accessory support bar, respectively, whereby the threaded tip portion becomes exposed relatively about an outward surface 12d of the accessory support bar so as to permit one to threadably attach thereto the star handle 36. Advantageously, but not necessarily or exclusively, via a disassociated condition of one the star handles, the locking bar 28 is pivotable so as to permit capture of cross rails 20 of the hub system between the adaptive ends thereof. Once the free unattached adaptive end of locking bar is returned to one of the apertures of the accessory support bar 12, the accessory fixture 10 may be readily affixed to the cross rails at any location between the hub and a point where the dimension between the cross rails approaches the dimension in between the apertures 26 of the accessory support bar. By advancing the star handles upon the threaded tip portions 34a, 34b of the adaptive ends of the locking bar, the cross rails 20 are tightly held in between the locking bar 28 and accessory support bar 12.

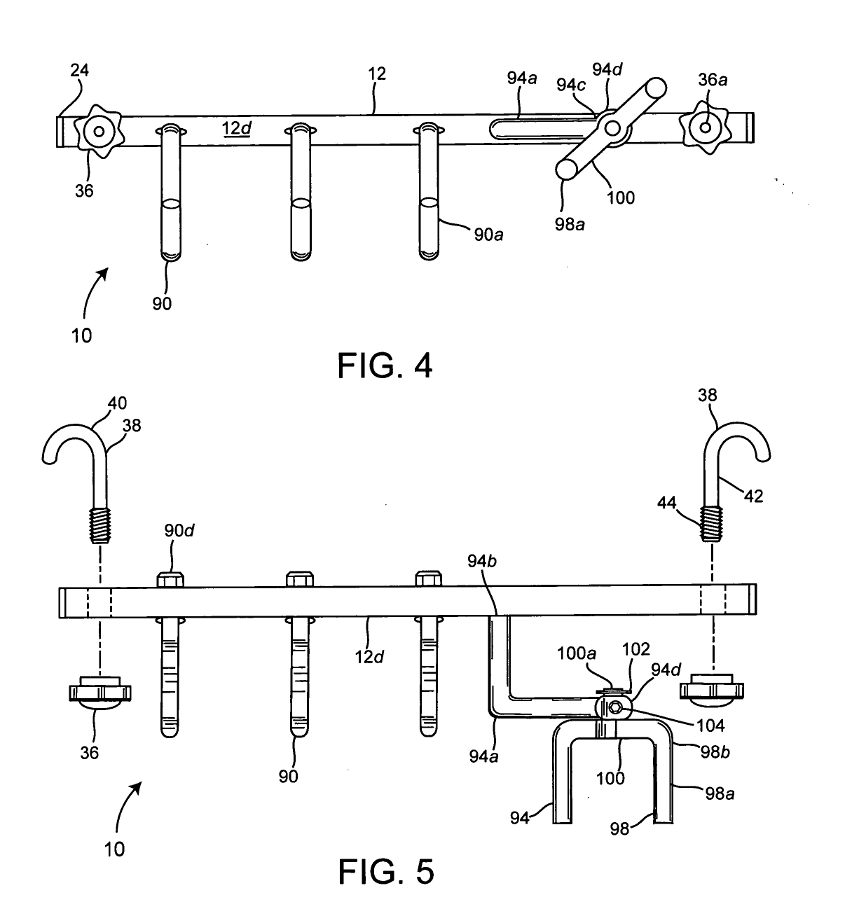

As illustrated in FIGS. 4 and 5, the clamping assembly 14 may alternatively comprise a pair of hooks 38 each having a u-shaped end 40 integrally connected to a shaft 42 having a threaded stem portion 44 that is suited to threadably accept thereto the star handle 36, wing nut, hex nut, or equivalent form of end fastener as previously mentioned. Assembly of the accessory support bar to a pair of cross rails 20 in this alternative instance comprises placement of the accessory support bar 12 at or near a location where the span of the cross rails approaches the dimension held in between the apertures of the accessory support bar, substantially in like manner described above. By inserting the shaft 42 and threaded stem portion 44 of the hook prematurely into the aperture of the accessory support bar 12 and attaching the star handle to the threaded stem portion in a loosely manner, the hook 38 can pivotally move relatively about the aperture 26 of the accessory support bar, which in turn, furthers sufficient opportunity of the u-shaped end 40 to align with, grasp and engage a circumferential portion of the cross rail. Once in this desired positioned, further tightening of the star handles serves to secure the accessory support bar 12 to the cross rails in the preferred manner set forth herein.

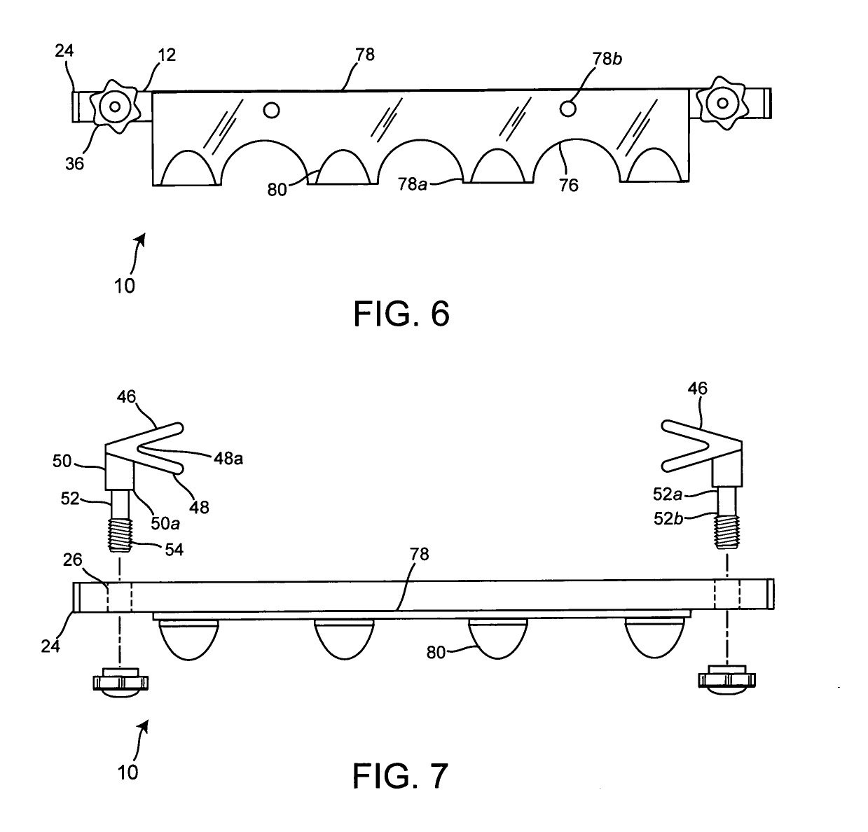

As represented in FIGS. 6 and 7, the clamping assembly 14 may comprise a third alternative form in the nature of a pair of frictional connectors 46 each having a pair of angular forks 48 integrally connected to a cylindrical body 50 substantially extending perpendicular to the orientation thereof. An end 52a of an extension 52 is further shown integrally connected to an outward end 50a of cylindrical body, whereas an opposite end 52b thereof comprises a threaded stem portion 54 that is suited to threadably accept thereto the star handle 36, wing nut, hex nut, or equivalent form of end fastener as noted above. Although similar in regard to the preferred mounting arrangement associated with the hooks 38, the accessory support bar 12, as loosely outfitted with a pair frictional connectors 46, is generally placed within a location dimensionally suited to reach about the span of the pair of cross rails 20, whereupon each frictional connector is then pivotally orientated in such manner to permit an interior portion 48a of the angular forks 48 to engage an outermost surficial portion 20a of the cross rail. Once in this desired position, the accessory support bar 12 is pushed downwardly in a lightly manner until the angular forks become fully frictionally engaged with the cross rails, after which time the star handles 36 are rotatably tightened to secure the accessory support bar to the cross rails.

In fulfilling the utilitarian aspects of the preferred embodiment of the accessory fixture 10, the accessory support bar 12 is fitted with a mix and match assortment of useable fixtures, particularly being suited to support, hold and retain any numerous forms of personal articles or belongings, including without limitation, articles of clothing, beverages, and sports gear in the nature of firearms, crossbows and other forms of weaponry often associated with the sport of hunting, for example.

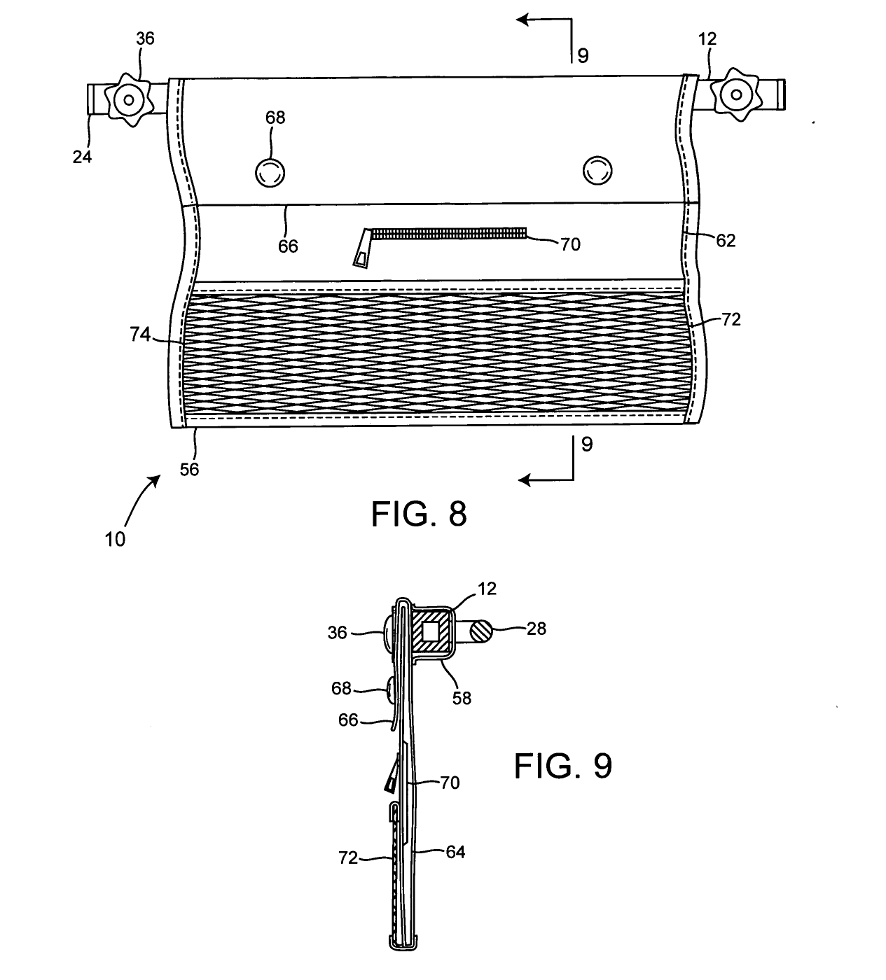

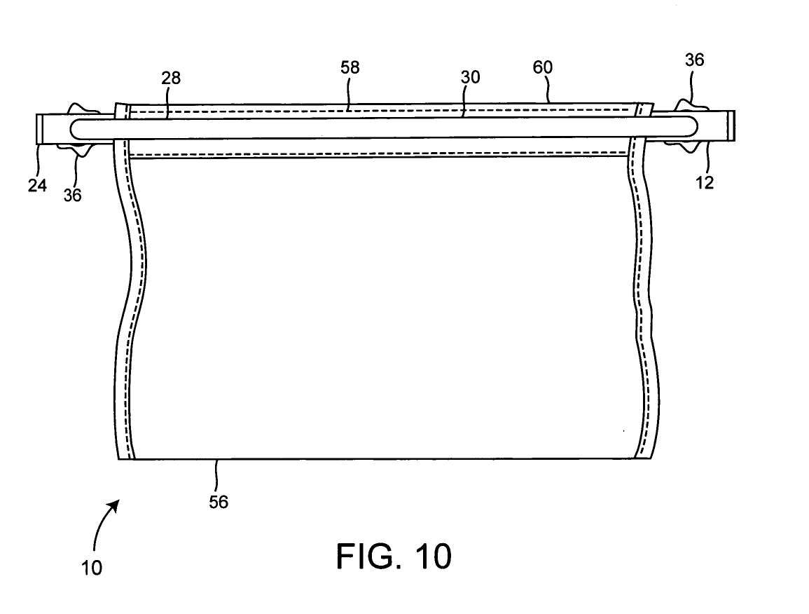

As depicted in FIGS. 8-10, the accessory support bar 12 may be featured with a first form of useable accessory in the nature of a pouch 56 preferentially comprising one or more interior compartments for long- or short-term storage of personal articles. The pouch is preferably mounted to the accessory support bar 12 by means of an elongate sleeve 58 selectively positioned and sewnly attached to an upper region 60 of the pouch, whereby the accessory support bar is slidably positioned within the sleeve to substantially support the pouch in suspension from and below the accessory support bar. As further illustrated in FIGS. 8 and 9, a frontal portion 62 of the pouch generally depicts access to a large compartment 64 outfitted with a protective flap 66 that is generally held in place by one or more snap buttons 68 or equivalent forms of fastening technology, such as a hook-and-loop fastener, buttons, semi-permanent tape, ties, etc. Immediately situated below the flap 66, as shown in FIG. 8, is a zippered compartment 70 for more secure retention and storage of personal articles, such as one's watch, jewelry, etc. and below the zippered compartment a frontal accessible compartment 72 being fabricated from netting 74 having stretchable characteristics for retaining and holding any numerous forms of personal articles for which necessitate immediate access and observation through the inherent perforations of the netting.

Alternative to utilization of the pouch 56, the accessory support bar 12 may be featured with a second form of useable accessory in the nature of a hanger 76 preferentially comprising a planar member 78 integrally connected to one or more planar hook elements 80 and situated in between the pair of apertures 26 integral to the accessory support bar. Each hook element, as depicted in FIG. 7, is angularly orientated sufficiently from a lower portion 78a of the planer member insofar to permit support of one or more articles of clothing and other personal items therefrom without occurrence of slippage. Placement of a fastener in the form of one or more rivets 78b, bolt and nut arrangements, or equivalent forms of fastener known in the art suffice as sufficient means for securing the hanger 76 to the outward surface 12d of the accessory support bar 12, substantially as shown in FIG. 6.

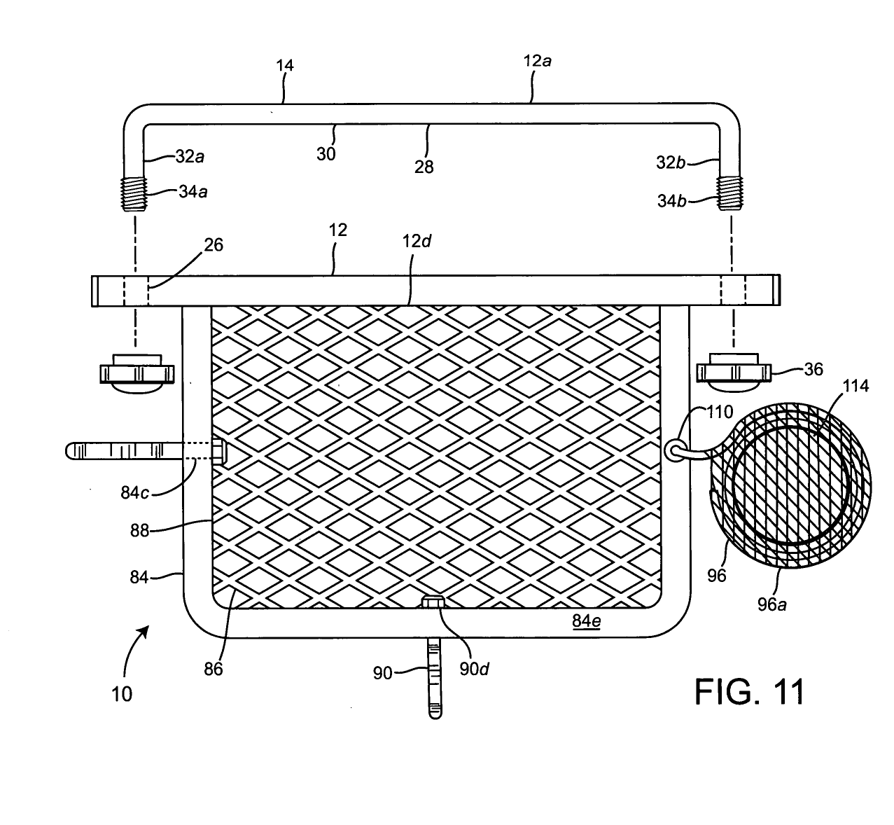

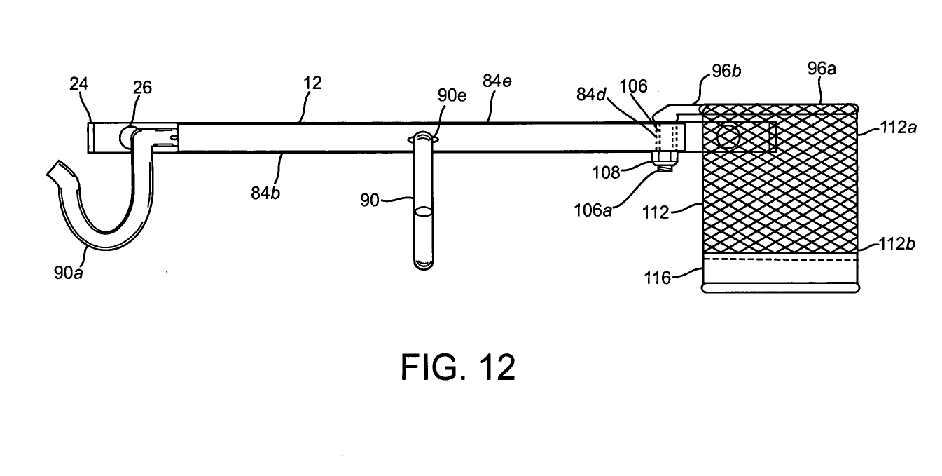

Alternative to utilization of the pouch 56 and hanger 76 noted above, the accessory support bar, as shown in FIGS. 11 and 12, may be featured with a third form of useable accessory in the nature of a shelf 82 preferentially comprising a rectangular-shaped frame 84 having ends 84a fixedly connected to the outward surface and positioned inwardly from and in between the apertures 26 of the accessory support bar. Although the frame 84 primarily serves to support a meshed bottom 86 having a periphery 88 connected along a bottom side 84b thereof, the frame may supplementarily serve to support one or more other forms of useable accessories, including, without limitation, one or more hooks 90, a gun support 92, a crossbow support 94, and a beverage container holder 96.

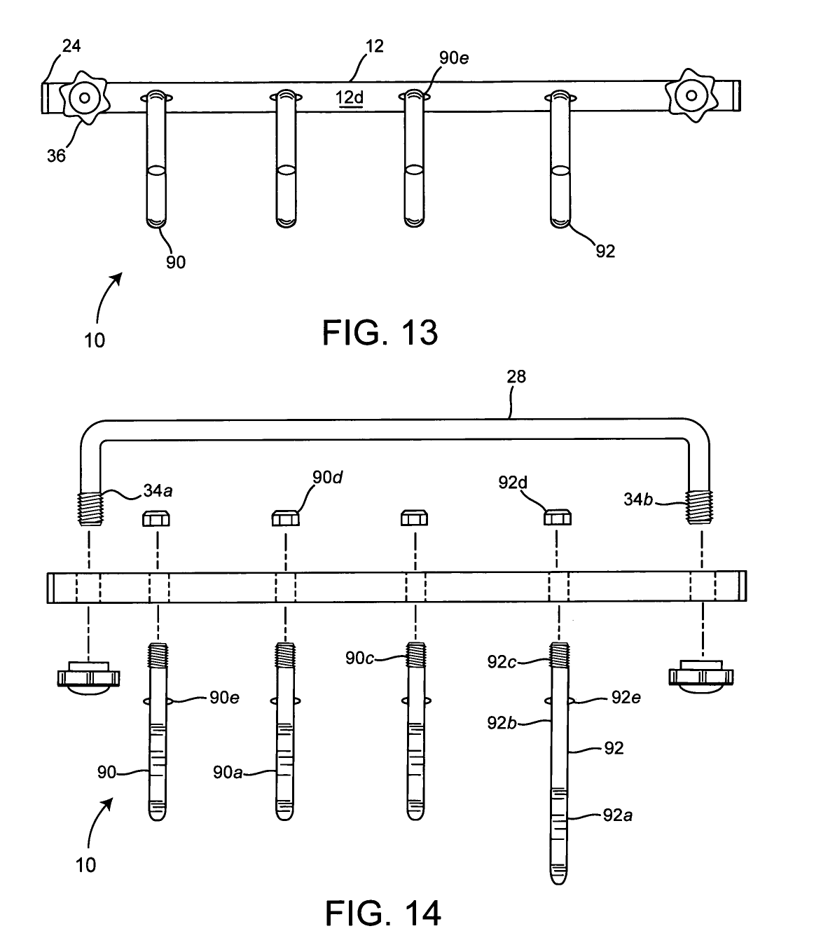

In reference to FIGS. 13 and 14, each hook 90 in this particular application comprises a u-shaped end 90a integrally connected to a shaft 90b having a threaded end 90c suited to accept a locking hex nut 90d or an equivalent form of end fastener. Similar in terms of overall construct of the hook, the gun support 92, as illustrated in FIG. 14, comprises a u-shaped end 92a integrally connected to a shaft 92b of greater length than that associated with the hook to separate and distinguish its function apart from simply supporting articles of clothing, for example. A threaded end 92c of the shaft threadably fitted with a locking hex nut 92d or an equivalent form of end fastener serves to secure the gun support to the frame or to the outward surface. In instances of their application, it may appropriate to outfit the shafts of the hook and gun support with an integral stop 90e, 92e to preset positional mounting and prevent over pulling of the u-shaped end inwardly toward one or more apertures 84c generally present within the frame 84 or outward surface for which is suited to accept either one or both of the shafts.

Conversely, the crossbow support 94 is shown in FIGS. 4 and 5 to preferentially comprise a L-shaped arm 94a having a first end 94b fixedly attached to the outward side of the accessory support bar and a second end 94c integrally connected to a toroidal member 94d. Supplementing the configuration of the crossbow support 94 is a u-shaped bracket 98 comprising a pair of outwardly extending arms 98a substantially being orientated in a parallel manner to one another with each of their inward ends 98b integrally connected to a base member 100, which is shown in FIG. 5 to comprise a perpendicular orientated shaft 100a extending outwardly therefrom midway in between and opposite the extending arms 98a. The perpendicular orientated shaft 100a is preferably inserted within the toroidal member 94d and held thereat by means of a snap ring 102, a retaining clip, cotter clip, or an equivalent type of fastener to prevent lateral movement relatively apart from the toroidal member. A pair of set screws 104 passing through opposing sides of the toroidal member and engaging into the perpendicular orientated shaft 100a, as illustrated in FIG. 5, effectively serves to secure the u-shaped bracket 98 to the toroidal member and inhibit pivotable movement thereabout for optimum secure positioning of the crossbow.

Referring now to FIGS. 2 and 3, the beverage container holder 96 is shown to comprise a semi-circular shaped frame 96a having an offsetting support arm 96b extending outwardly therefrom. The offsetting support arm, in the particular embodiment of the beverage container holder shown in FIG. 12, is integrally coupled to a downward mount shaft 106 substantially being orientated perpendicular thereto and semi-circular shaped frame 96a and having a threaded end portion 106a for threadably accepting thereon a locking nut 108 or an equivalent form of end fastener and an integral stop 110 to the likes provided for the hooks. Alternatively, the offsetting support arm in applications absent of the shelf's frame, the offsetting support arm may only comprise the threaded end portion 106a and thus is directly placed within an aperture extending through the outward surface of the accessory support bar 12 and secured thereabout by means of the locking nut, as typically illustrated in FIG. 3. Supplementing the construct of the beverage container holder 96 is a cylindrical sleeve 112 having an upper portion 112a that wrappingly engages about and suspends from the semi-circular shaped frame 96a. The sleeve is further shown in FIGS. 2 and 12 as being sewnly connected to the periphery of a circular bottom 114 and reinforced by means of a circumferential band 116 placed about the circumference of a lower portion 112b of the sleeve, thus establishing an overall configuration that approximates the cylindrical shape of a beverage or soda can as known in the art. Preferably, the sleeve and bottom are fabricated from meshing or netting material to offer respectful retention and support of the beverage can while accommodating compactness during storage and transport. Mounting of the beverage container holder 96 to the frame 84 of the shelf occurs in similar fashion as for the hooks, wherein the downward mount shaft 106 is placed within an aperture 84d extending through a topside 84e of the frame and secured thereat by means of the locking nut.

Although it has been expressed hereinabove that one or more other forms of useable accessories may be incorporated into and utilized in association with the shelf's frame, as particularly illustrated and described above, it is equally understood that the accessory support bar 12 in its own right, absent a shelf, may incorporate usage of the useable accessories, such as those enumerated above, but without limitation, one or more hooks 90, a gun support 92, a crossbow support 94, and a beverage container holder 96, etc. In some instances of adaptation, particularly in this regard, slight alteration of the useable accessory and/or the accessory support bar may become necessary to fit appropriate functionality or the occasion, such as in the case of the beverage container holder, where it is not necessary to have present the downward mount shaft 106 if mounting thereof is desired on the outward surface 12d of the accessory bar, for example. FIGS. 1, 2, 5, 6, 8, and 12 demonstratively illustrate the wide possible arrangements of useable accessories contemplated herein. In this regard and as a preliminary matter, it should be readily appreciated that the depicted functionalities in furtherance of the organization of contemplated useable accessories may be a mix and match type affair, with form fitting function. Adaptation of the structures of the depicted or contemplated useable accessories in furtherance of user demands or preference are to be expected and are generally enabled with a modular approach, namely, by way of example, the substitution of one hook style for another, a crossbow support in lieu of or in addition to a gun support, a hanger in lieu of a shelf, and so forth.

It should be readily appreciated with reference to FIG. 1, as discussed above, that in as much as the height of the hub in relation to the floor or ground may vary, and the angle in between the adjacent cross rails may vary, so too may the span of the accessory fixture 10 vary. Accordingly, a shorter spanned or dimensioned accessory fixture will occupy a higher elevation than an accessory fixture of longer span. Moreover, while not shown, it is contemplated that the accessory fixture may include one or more floor or ground engaging elements in furtherance of stabilization of a longer spanned fixture and relief of the stress(es) at the affixation point for a larger/heavier fixture, or fixture rated for a heavier duty use. Moreover, it may, under select circumstances or user preference, to position the accessory fixture above the hub upon the cross rails.

It is obvious that the components comprising the accessory fixture 10 may be fabricated from a variety of materials, providing such selection or use of materials possess the capacity to withstand forces acting thereon throughout its duration of use in an outdoor setting. Accordingly, it is most desirable, and therefore preferred, to construct the accessory support bar 12, locking bar 28, shelf 82, and useable accessories from aluminum, steel, a high strength polymeric material, or an equivalent material sufficiently suited to yield structural support. To enable use of the accessory fixture within a possible moisture-laden, more or less in an outdoor environment, the accessory support bar 12 and shelf components may be powder coated, whereas the locking bar and useable accessories may be coated with a polymeric or rubberized coating or equivalent.

While there has been shown and described a particular embodiment of the invention, it will be obvious to those skilled in the art that various changes and alterations can be made therein without departing from the invention and, therefore, it is aimed in the appended claims to cover all such changes and alterations which fall within the true spirit and scope of the invention.

What is claimed is:

1. An accessory fixture for a temporary shelter having a pair of angularly orientated cross rails connected to and emanating from a hub, said accessory fixture comprising, in combination:
an accessory support bar having a predetermined length that at least approximates the separable distance in between the pair of cross rails; and
a clamping assembly for attaching to said accessory support bar and engaging simultaneously the pair of cross rails so as to support and retain positioning of said accessory support bar thereabout.

2. An accessory fixture as set forth in claim 1, wherein said accessory support bar comprises an outward surface and first and second ends each having an aperture extending therethrough for accepting said clamping assembly.

3. An accessory fixture as set forth in claim 2, wherein said clamping assembly comprises a locking bar having an elongate intermediate member integrally connected to and situated in between first and second adaptive ends, said adaptive ends each having a threaded tip portion and being configured to extend perpendicularly outward from said elongate intermediate member.

4. An accessory fixture as set forth in claim 3, wherein said threaded tip portions of the adaptive ends pass through said apertures of first and second ends to threadably receive thereon end fasteners that suffice to tightly engage the cross rails in between said locking bar and said accessory support bar.

5. An accessory fixture as set forth in claim 2, wherein said clamping assembly comprises a pair of end fasteners and a pair of hooks each having a u-shaped end integrally connected to a shaft having a threaded stem portion, whereby said threaded stem portions pass into and through said apertures of the accessory support bar to threadably accept thereon said end fasteners while said u-shaped ends engage about the cross rails so as to support and retain positioning of said accessory support bar thereabout.

6. An accessory fixture as set forth in claim 2, wherein said clamping assembly comprises a pair of end fasteners and a pair of frictional connectors each having a pair of angular forks integrally connected to a cylindrical body substantially extending perpendicular to the orientation thereof, said cylindrical body comprising an outward end integrally connected to an extension having a threaded stem portion, whereby said threaded stem portions pass into and through said apertures of the accessory support bar to threadably accept thereon said end fasteners while said angular forks frictionally engage with the cross rails so as to support and retain positioning of said accessory support bar thereabout.

7. An accessory fixture as set forth in claim 1, further comprising a pouch having a plurality of compartments and an upper region for sewnly attaching thereabout an elongate sleeve for slidably receiving therethrough said accessory support bar.

8. An accessory fixture as set forth in claim 7, wherein said compartments comprise a large compartment having a protective flap secured by at least one snap button, a zipper compartment for secure retention and storage of personal articles, and a frontal accessible compartment being fabricated from netting having stretchable characteristics and perforations.

9. An accessory fixture as set forth in claim 2, further comprising a hanger having a planar member integrally connected to one or more hook elements positioned at a lower portion thereof, said planar member being mounted to said outward surface of the accessory support bar by a fastener in the form of rivets.

10. An accessory fixture as set forth in claim 2, further comprising a shelf having a meshed bottom and a rectangular-shaped frame with ends fixedly connected to said outward surface and positioned inwardly from and in between said apertures of the accessory support bar.

11. An accessory fixture as set forth in claim 10, further comprising one or more hooks each having a u-shaped end integrally connected to a shaft comprising a threaded end for threadably accepting thereon a locking hex nut, said frame having an aperture extending therethrough to accept said threaded end of the shaft so as to serve in mounting said hook to said frame, said shaft having an integral stop to preset positional mounting of said hook and prevent over pulling of said u-shaped end inwardly toward said aperture of the frame.

12. An accessory fixture as set forth in claim 10, further comprising one or more gun supports each having a u-shaped end integrally connected to an extended shaft comprising a threaded end for threadably accepting thereon a locking hex nut, said frame having an aperture extending therethrough to accept said threaded end of extended shaft so as to serve in mounting said gun support to said frame, said extended shaft having an integral stop to preset positional mounting of said gun support and prevent over pulling of said u-shaped end inwardly toward said aperture of the frame.

13. An accessory fixture as set forth in claim 10, further comprising one or more crossbow supports each having a L-shaped arm with a first end thereof fixedly attached to said frame and a second end integrally connected to a toroidal member, said crossbow support further comprising a u-shaped bracket having a pair of outwardly extending arms substantially being orientated in a parallel manner to one another, said outwardly extending arms having inward ends integrally connected to a base member, said base member having a perpendicular orientated shaft extending outwardly therefrom midway in between and opposite of said outwardly extending arms, said perpendicular orientated shaft being placed within said toroidal member and held thereat by a snap ring and a pair of set screws passing through opposing sides of said toroidal member to engage with said perpendicular orientated shaft.

14. An accessory fixture as set forth in claim 10, further comprising one or more beverage container holders each having a cylindrical sleeve and a semi-circular shaped frame comprising an offsetting support arm extending outwardly therefrom, said offsetting support arm having a downward mount shaft substantially being orientated perpendicular thereto, said downward mount shaft having an integral stop and a threaded end portion for passing through an aperture of said frame and threadably accepting thereon a locking hex nut, said cylindrical sleeve having an upper portion wrappingly engaging and connecting to said semi-circular shaped frame and a lower portion sewnly connected to a bottom as reinforced by a circumferential band placed thereabout.

15. An accessory fixture as set forth in claim 2, further comprising one or more hooks each having a u-shaped end integrally connected to a shaft comprising a threaded end for threadably accepting thereon a locking hex nut, said outward surface of the accessory support bar having an aperture extending therethrough to accept said threaded end of shaft so as to serve in mounting said hook to said accessory support bar, said shaft having an integral stop to preset positional mounting of said hook and prevent over pulling of said u-shaped end inwardly toward said aperture of the outward surface.

16. An accessory fixture as set forth in claim 2, further comprising one or more gun supports each having a u-shaped end integrally connected to an extended shaft comprising a threaded end for threadably accepting thereon a locking hex nut, said outward surface of the accessory support bar having an aperture extending therethrough to accept said threaded end of the extended shaft so as to serve in mounting said gun support to said accessory support bar, said extended shaft having an integral stop to preset positional mounting of said gun support and prevent over pulling of said u-shaped end inwardly toward said aperture of the outward surface.

17. An accessory fixture as set forth in claim 2, further comprising one or more crossbow supports each having a L-shaped arm with a first end thereof fixedly attached to said outward surface of the accessory support bar and a second end integrally connected to a toroidal member, said crossbow support further comprising a u-shaped bracket having a pair of outwardly extending arms substantially being orientated in a parallel manner to one another, said outwardly extending arms having inward ends integrally connected to a base member, said base member having a perpendicular orientated shaft extending outwardly therefrom midway in between and opposite of said outwardly extending arms, said perpendicular orientated shaft being placed within said toroidal member and held thereat by a snap ring and a pair of set screws passing through opposing sides of said toroidal member to engage with said perpendicular orientated shaft.

18. An accessory fixture as set forth in claim 2, further comprising one or more beverage container holders each having a cylindrical sleeve and a semi-circular shaped frame comprising an offsetting support arm extending outwardly therefrom, said offsetting support arm having an integral stop and a threaded end portion for passing through an aperture of said outward surface and threadably accepting thereon a locking hex nut, said cylindrical sleeve having an upper portion wrappingly engaging and connected to said semi-circular shaped frame and a lower portion sewnly connected to a bottom as reinforced by a circumferential band placed thereabout.

19. An accessory fixture for a temporary shelter having a pair of angularly orientated cross rails connected to and emanating from a hub, said accessory fixture comprising, in combination:
an accessory support bar having a predetermined length that at least approximates the separable distance in between the pair of cross rails, an outward surface, and first and second ends each having an aperture extending therethrough;
a locking bar having an elongate intermediate member integrally connected to and situated in between first and second adaptive ends, said adaptive ends each having a threaded tip portion and being configured to extend perpendicularly outward from said elongate intermediate member, said threaded tip portions of the adaptive ends being configured to pass through said apertures of the first and second ends to threadably receive thereon end fasteners that suffice to tightly engage the cross rails in between said locking bar and said accessory support bar;
one or more hooks each having a u-shaped end integrally connected to a shaft comprising a threaded end for threadably accepting thereon a locking hex nut, said outward surface of the accessory support bar having an aperture extending therethrough to accept said threaded end of shaft so as to serve in mounting said hook to said accessory support bar, said shaft having an integral stop to preset positional mounting of said hook and prevent over pulling of said u-shaped end inwardly toward said aperture of the outward surface;
one or more gun supports each having a u-shaped end integrally connected to an extended shaft comprising a threaded end for threadably accepting thereon a locking hex nut, said outward surface of the accessory support bar having an aperture extending therethrough to accept said threaded end of the extended shaft so as to serve in mounting said gun support to said accessory support bar, said extended shaft having an integral stop to preset positional mounting of said gun support and prevent over pulling of said u-shaped end inwardly toward said aperture of the outward surface;
one or more crossbow supports each having a L-shaped arm with a first end thereof fixedly attached to said outward surface of the accessory support bar and a second end integrally connected to a toroidal member, said crossbow support further comprising a u-shaped bracket having a pair of outwardly extending arms substantially being orientated in a parallel manner to one another, said outwardly extending arms having inward ends integrally connected to a base member, said base member having a perpendicular orientated shaft extending outwardly therefrom midway in between and opposite of said outwardly extending arms, said perpendicular orientated shaft being placed within said toroidal member and held thereat by a snap ring and a pair of set screws passing through opposing sides of said toroidal member to engage with said perpendicular orientated shaft; and
one or more beverage container holders each having a cylindrical sleeve and a semi-circular shaped frame comprising an offsetting support arm extending outwardly therefrom, said offsetting support arm having an integral stop and a threaded end portion for passing through an aperture of said outward surface and threadably accepting thereon a locking hex nut, said cylindrical sleeve having an upper portion wrappingly engaging and connecting to said semi-circular shaped frame and a lower portion sewnly connected to a bottom as reinforced by a circumferential band placed thereabout.

20. An accessory fixture for a temporary shelter having a pair of angularly orientated cross rails connected to and emanating from a hub, said accessory fixture comprising, in combination:
an accessory support bar having a predetermined length that at least approximates the separable distance in between the pair of cross rails, an outward surface, and first and second ends each having an aperture extending therethrough;
a locking bar having an elongate intermediate member integrally connected to and situated in between first and second adaptive ends, said adaptive ends each having a threaded tip portion and being configured to extend perpendicularly outward from said elongate intermediate member, said threaded tip portions of the adaptive ends being configured to pass through said apertures of the first and second ends to threadably receive thereon end fastener that suffice to tightly engage the cross rails in between said locking bar and said accessory support bar;
a shelf having a meshed bottom and a rectangular-shaped frame with ends fixedly connected to said outward surface and positioned inwardly from and in between said apertures of the accessory support bar;
one or more hooks each having a u-shaped end integrally connected to a shaft comprising a threaded end for threadably accepting thereon a locking hex nut, said frame having an aperture extending therethrough to accept said threaded end of the shaft so as to serve in mounting said hook to said frame, said shaft having an integral stop to preset positional mounting of said hook and prevent over pulling of said u-shaped end inwardly toward said aperture of the frame;
one or more gun supports each having a u-shaped end integrally connected to an extended shaft comprising a threaded end for threadably accepting thereon a locking hex nut, said frame having an aperture extending therethrough to accept said threaded end of extended shaft so as to serve in mounting said gun support to said frame, said extended shaft having an integral stop to preset positional mounting of said gun support and prevent over pulling of said u-shaped end inwardly toward said aperture of the frame;
one or more crossbow supports each having a L-shaped arm with a first end thereof fixedly attached to said frame and a second end integrally connected to a toroidal member, said crossbow support further comprising a u-shaped bracket having a pair of outwardly extending arms substantially being orientated in a parallel manner to one another, said outwardly extending arms having inward ends integrally connected to a base member, said base member having a perpendicular orientated shaft extending outwardly therefrom midway in between and opposite of said outwardly extending arms, said perpendicular orientated shaft being placed within said toroidal member and held thereat by a snap ring and a pair of set screws passing through opposing sides of said toroidal member to engage with said perpendicular orientated shaft; and
one or more beverage container holders each having a cylindrical sleeve and a semi-circular shaped frame comprising an offsetting support arm extending outwardly therefrom, said offsetting support arm having a downward mount shaft substantially being orientated perpendicular thereto, said downward mount shaft having an integral stop and a threaded end portion for passing through an aperture of said frame and threadably accepting thereon a locking hex nut, said cylindrical sleeve having an upper portion wrappingly engaging and connecting to said semi-circular shaped frame and a lower portion sewnly connected to a bottom as reinforced by a circumferential band placed thereabout.
